(19) United States
(12) Patent Application Publication
(10) Pub. No.: US 2007/0026112 A1
(43) Pub. Date: Feb. 1, 2007

(54) Container combining beverage and secondary consumable product

(75) Inventors: Douglas Zimmerman, Stratford, CT (US); John Eaton, Oxford, CT (US); Erica Nozato, Ridgefield, CT (US)

Correspondence Address: HOFFMANN & BARON, LLP, 6900 JERICHO TURNPIKE, SYOSSET, NY, 11791, US

(73) Assignee: Cadbury Adams USA LLC

(21) Appl. No.: 11/497,068

(22) Filed: Aug. 1, 2006

Related U.S. Application Data
(60) Provisional application No. 60/704,305, filed on Aug. 1, 2005.
(60) Provisional application No. 60/711,646, filed on Aug. 26, 2005.

(51) Int. Cl. A23B 7/148

(52) U.S. Cl. 426/106

(57) ABSTRACT

The present invention relates to a beverage container which also supports a secondary consumable product to be consumed in conjunction with the beverage. More specifically, in some embodiments, the present invention provides a packaging device for placing a consumable product in combination with a beverage. The packaging device includes: a container surface forming at least part of a beverage container; a recess formed in the surface for supporting the consumable product; and a cover overlying the recess and sealing the consumable product. An association is provided between the beverage and the consumable product which provides enhancement of consumption of the beverage and the consumable product.

### CROSS REFERENCE

This application claims the benefit of U.S. provisional patent application Ser. No. 60/704,305, which was filed on Aug. 1, 2005 and U.S. provisional patent application Ser. No. 60/711,646, which was filed on Aug. 26, 2005, all of which is incorporated by reference herein.

### FIELD OF INVENTION

The present invention relates generally to a beverage container. More particularly, the present invention relates to a beverage container which also supports a secondary consumable product to be consumed in conjunction with the beverage.

### BACKGROUND OF INVENTION

A consumer often associates consumption of a beverage with the consumption of another consumable product. For example, it is common for snack foods to be consumed with beverages such as beer and soda. Also, it is common for therapeutic and health related consumables to be taken with water. In an effort to capitalize on this association, the art has seen a variety of packaging structures which attempt to couple a beverage with a secondary consumable product in a conjoined package.

One example of such a combination package is shown in U.S. Patent Application Publication No. 2003/0213707. This publication discloses a package for snack food which is attached and sold along with a beverage bottle such as a beer or soda bottle.

Another example is shown in U.S. Patent Application Publication No. 2005/0040052. This publication discloses the combination of a therapeutic secondary consumable such as an aspirin with a beverage such as water.

In the '707 publication, the snack food is enclosed in a pouch which is hung around the neck of the bottle. In the '052 publication, the secondary product, such as the aspirin tablet, is supported in a recess in the bottle cap. Neither of these arrangements provides an easy to use or aesthetically pleasing design.

The need for an enhanced package which couples a beverage and secondary consumable product is especially seen where there is a direct relationship between the beverage and the secondary consumable product.

### SUMMARY OF THE INVENTION

The present invention provides a packaging device for placing a consumable product in combination with a beverage. The packaging device includes a container surface forming at least a part of a beverage container. A recess is formed in the surface for supporting the consumable product. A cover overlies and seals the consumable product in the recess. An association is provided between the beverage and the consumable product which provides enhancement of the consumption of the beverage and the consumable product.

More specifically, the present invention provides a container having consumable liquid contained therein. The liquid includes a first component. The container also supports a confectionary delivery vehicle located on the container. The phrase “located on the container” includes within the recess space or cavity of the container, as described herein, on the external surface of the container, as well as on or in a beverage or bottle cap. The confectionary delivery vehicle includes a second component. The first and second components may be the same or different and may be selected from the group consisting of a flavor agent, a sensate agent, a bioactive agent, an nutritional supplement and pharmaceutical agent. The first component in the liquid composition may provide a sensory experience or health benefit. The second component in the confectionary delivery vehicle may supplement, complement or enhance the sensory experience or health benefit.

Specifically, the container of the present invention may include a beverage bottle having a wall defining an interior for accommodating the beverage. The beverage bottle further includes a cavity formed therein for accommodating the secondary consumable product. The cavity has a closed end extending into the interior of the bottle and a open face flush with the wall of the bottle. A cover overlies the open front face of the cavity and sealably closes the cavity. The cavity may be located at various positions along the beverage bottle.

In a method aspect of the present invention, a method of modulating a sensory experience or health benefit to a consumer is disclosed. The method includes providing a product, including a container having consumable liquid composition contained therein. The liquid composition includes a first component. The product also includes a confectionary delivery vehicle located on an external surface of the container. The delivery vehicle includes a second component. The first and second components may be the same or different and are selected from the group consisting of a flavor agent, a sensate agent, a bioactive agent, a nutritional supplement and a pharmaceutical agent. The liquid composition is consumed by an individual through the oral cavity thereby delivering the first component to the individual. Subsequently, the delivery vehicle is consumed by the individual through the oral cavity to deliver the second component.

### BRIEF DESCRIPTION OF THE DRAWINGS

FIG. 1 is a perspective showing of one embodiment of the container of the present invention.

FIG. 2 is a partial sectional showing the container of FIG. 1 taken through the lines 2-2.

FIG. 3 is a cross-sectional showing of a further embodiment of the container of the present invention.

FIG. 4 is a cross-sectional showing of a still further embodiment of the container of the present invention.

FIG. 5 shows a snap-lid which may be used in accordance with the present invention.

FIG. 6 shows a beverage cup lid formed in accordance with the present invention.

FIG. 7 is a perspective showing of a further embodiment of a container employed in accordance with the present.

FIG. 8 is a perspective showing of another embodiment of a cap formed in accordance with the present invention.

### DETAILED DESCRIPTION OF THE PREFERRED EMBODIMENTS

Referring to the Figures as can be seen, the present invention provides a beverage container such as a bottle which accommodates in association therewith a secondary consumable product which can take a wide variety of forms. In the present embodiment the container preferably accommodates a wide variety of beverages and the container also accommodates a wide variety of shapes, forms and types of secondary products.

In accordance with the present invention, the beverage may be a consumable liquid composition which includes a first component. The secondary consumable product may be a confectionary delivery vehicle having a second component. The first and second components may be the same or different. It is further contemplated that the first and second components may include a variety of agents. Such agents may include, but are not limited to, flavor agents, sensate agents, bioactive agents, nutritional supplements, and pharmaceutical agents.

There may be a relationship between the first and second components contained in the beverage and the secondary consumable product. For example, components may provide a sensory experience or a health benefit. In these situations, the second component may be of the type which supplements, complements, or otherwise enhances the sensory experience or a health benefit. The relationship between the first component and second component may have a synergistic effect in providing the sensory experience or health benefit. More particularly, the beverage and the secondary consumable product may be selected from pairs of such products which are commonly used in association with each other.

Examples of a variety of suitable components for use in chewing gums and other confectioneries are disclosed in Assignee's co-pending application Ser. No. 60/650,758, entitled “Liquid-Filled Chewing Gum Compositions”, and filed on Feb. 7, 2005, and Assignee's co-pending application Ser. No. 60/683,634, entitled “Methods and Delivery Systems for Managing Release of One or More Ingredients in an Edible Composition”, and filed on May 23, 2005, the contents of which are incorporated herein by reference in their entirety.

Examples of other suitable components for use in beverages and/or secondary consumable products are disclosed in the following patents and patent application publications, the contents all of which are incorporated herein by reference in their entirety: U.S. Patent Publication No. 2003/0138518 A1 (center-filled chewing gums containing calcium); U.S. Pat. No. 5,422,128 (calcium-supplemented beverages); U.S. Patent Publication No. 2004/0234459 (use of stanol compounds in cholesterol reducing chewing gums); U.S. Pat. No. 6,576,285 (use of sterol or stanol esters in cholesterol lowering beverages); U.S. Pat. No. 6,251,193 (vitamin-containing confectioneries); U.S. Pat. No. 4,992,282 (vitamin-containing beverages); U.S. Pat. No. 6,326,040 (vitamin-containing beverages); U.S. Pat. No. 3,652,290 (beverages containing Vitamin C); U.S. Patent Publication No. 2004/0071681 A1 (crave-reducing confectioneries); U.S. Patent Publication No. 2003/0148016 A1 (energy fitness water); Assignee's co-pending application Ser. No. 60/600,649, entitled “Warming Compositions and Delivery Systems Therefor”, and filed on Aug. 11, 2004 (warming agents in confectioneries and beverages); Assignee's co-pending application Ser. No. 60/668,670, entitled “Sensate Compositions and Delivery Systems Therefor”, and filed on Apr. 6, 2005 (sensates in confectioneries and beverages); U.S. Pat. No. 6,444,241 (caffeine in chewing gums); U.S. Pat. No. 4,673,578 (dietary fibers in confectioneries); U.S. Pat. No. 4,882,160 (dietary fibers in chewable confectioneries); U.S. Patent Publication No. 2005/0031711 A1 (ginseng in beverages); U.S. Pat. No. 5,912,030 (extended additive release for comestibles and beverages); U.S. Pat. No. 6,326,400 (appetite enhancer for foods and beverages); U.S. Pat. No. 6,432,929 (cartilage enhancer for foods and beverages); U.S. Pat. No. 6,251,461 (hops extract as an antimicrobial extract in foods and beverages); U.S. Pat. No. 6,620,452 (plant phenolics as food and beverage supplement); U.S. Pat. No. 4,886,665 (food and beverage supplement containing oat and nettle extract); U.S. Pat. No. 5,466,453 (pine extract improver for use in foods and beverages); and U.S. Pat. No. 6,203,837 (coffee extract).

In most cases, the consumer wishing to consume a beverage and a secondary consumable product together must separately obtain the beverage and the secondary product. The present invention provides the ability to package, fill and dispense the beverage in combination with the secondary consumable product so as to provide direct and immediate association therebetween.

In describing the preferred embodiments of the present invention, reference will be made generically to a beverage and a secondary consumable product. However, these terms are meant in their broadest sense and are not intended to be limiting.

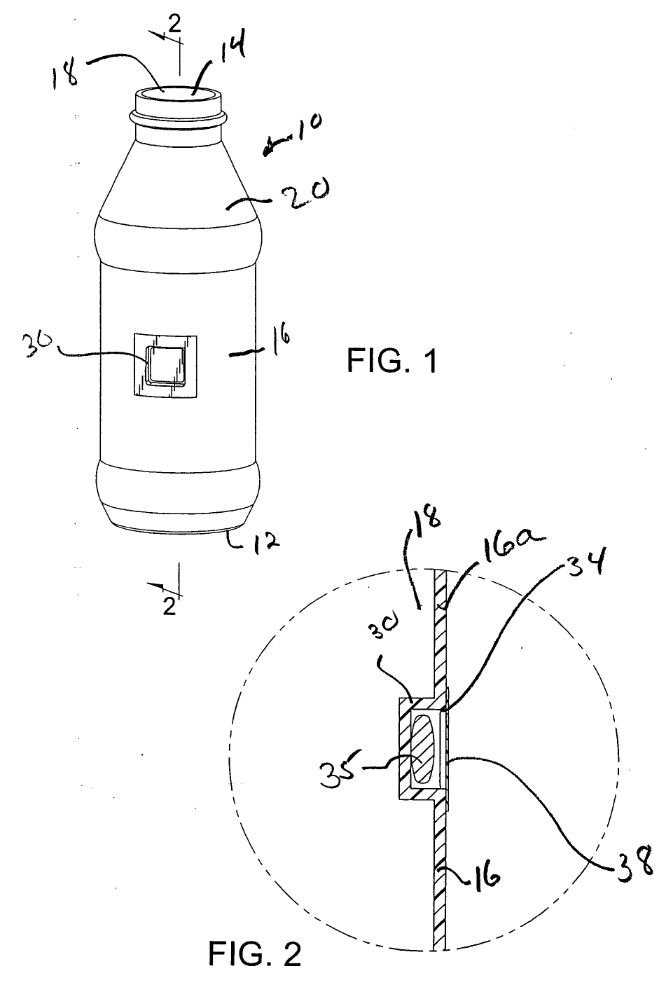

Referring now to FIGS. 1 and 2, one embodiment of the present invention is shown. The container of the present invention takes the form of a beverage bottle 10 which may be of typical conventional construction having a closed bottom end 12, an open upper end 14 which is used to fill and dispense the beverage and a generally cylindrical body 16 defining a bottle interior 18 which contains the beverage.

As is well known in bottle art, bottle 10, may also include a frustoconical upper end 20 transitioning from cylindrical body 16 to the open upper end 14. The bottle 10 of the present invention may take other shapes and forms. The bottle 10 may be formed of a wide variety of well known materials and may be formed from various forming techniques.

As is more specifically shown in FIG. 2, bottle 10 of the present invention includes a support cavity 30 formed directly in the cylindrical portion 16 thereof. Support cavity 30 is molded into the wall 16a forming the cylindrical portion 16 of bottle 10. The cavity shown in FIG. 2 is generally of square configuration so as to accommodate a generally square secondary consumable product 35. As the present invention is designed to support a variety of secondary consumable products, the particular shape of cavity 30 may be varied in accordance therewith. Similarly, the depth of cavity 30 may also be varied so as to accommodate the particular secondary product 35.

Cavity 30 extends into the interior 18 of bottle 10. Cavity 30 includes an open front face 34 which goes generally flush with the wall 16a of bottle 10. The open front face 34 of cavity 30 is closed by a film like cover 38 which spans the open front face 34 of cavity 30 thereby effectively sealing and enclosing the secondary product 35 within the cavity 30. The film like cover 38 may be formed of a wide variety of well known materials and may be transparent so as to permit viewing of the secondary product 35 contained within the cavity. The cover 38 may be adhesively sealed to the wall 16a of bottle 10 so as to removeably secure the cover thereto.

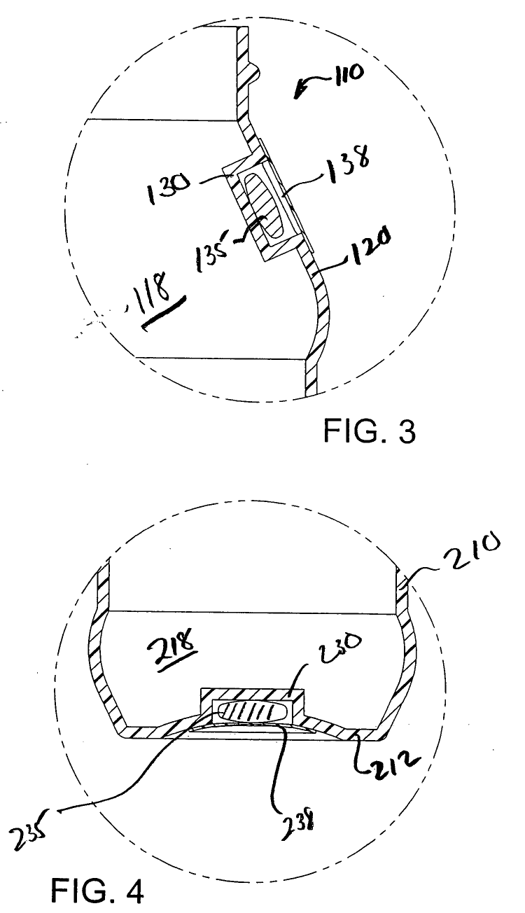

Referring now to FIG. 3, a further embodiment of the present invention is shown. The embodiment of FIG. 3 bottle 110 includes a cavity 130 formed in the frustroconical upper end 120 thereof. Cavity 130 is substantially similar to cavity 30 described above and extends in to the interior 118 of bottle 110. The cavity supports a secondary consumable product 135 therein. A cover 138 similarly encloses the cavity 130.

A still further embodiment of the present invention is shown in FIG. 4 where a bottle 210 includes a cavity 230 formed on the closed lower end 212 thereof. As is well known in the bottle art the closed bottom end 212 of bottle 210 includes a concave recess or “punt” for strength and stability. Cavity 230 extends inwardly from this bottom end into the interior 218. The cavity 230 supports a secondary consumable products 235 therein. A cover 238 encloses the open front face of the cavity as described above.

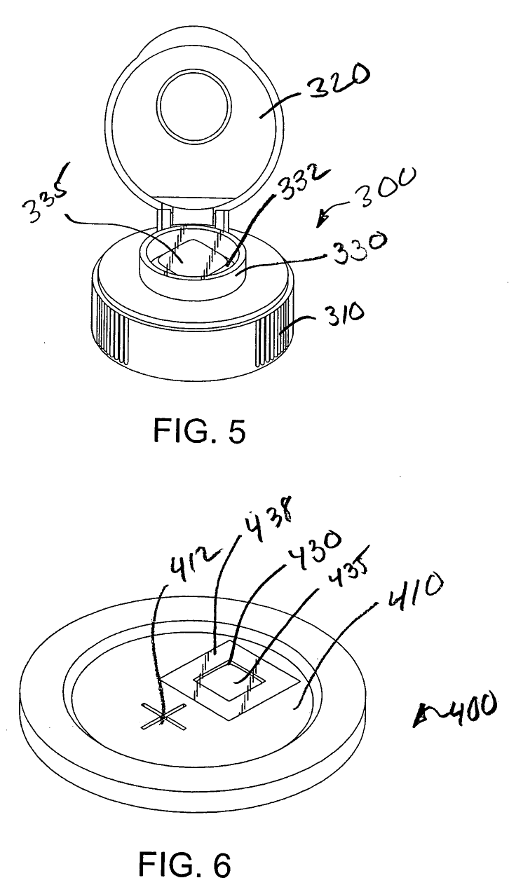

Referring now to FIG. 5 a further embodiment of the present invention is shown. In this embodiment is a snap lid cap 300 is shown. The cap 200 may be used in conjunction with any conventional beverage container (not shown). The cap includes a main cylindrical body 310 which is attached to the open end of the container. The cap also includes a flip top 320 which is used to open and close a central opening 330 in base 310. The central opening 330 is bound by an extending cylindrical wall 334. The cap may include a thin membrane 332 across the opening 330 so as to provide both a seal to the beverage container as well as a seating location to support a secondary consumable product 335. Flip top 320 therefore is used to close both the beverage container as well as to enclose the secondary consumable product 335 within the cylindrical wall cap 334 of cap 300.

A further embodiment of the present invention is shown with respect to FIG. 6. In this embodiment a beverage cup lid 400 is shown. Beverage cup lid 400 is the type that is used in connection with disposable paper and plastic beverage cups. The lid 400 includes generally planar base 410 having a pierceable location 412 which permits entry of a straw or similar device. Planar portion 410 has formed therein a recess or cavity 430 which is used to accommodate secondary consumable product 435. A cover 438 such as that described above may be used to seal and enclose the secondary consumable product 435 within the cavity 430.

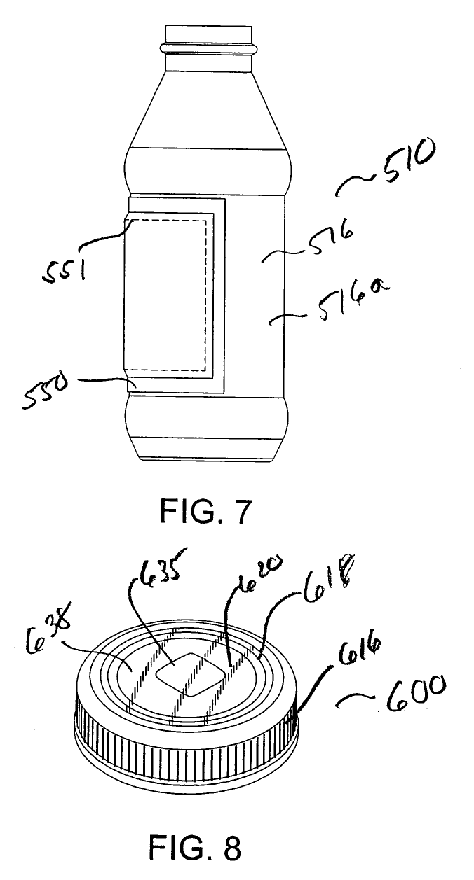

Referring now to FIG. 7, bottle 510 of the type described with respect to the embodiment of FIG. 1 is shown. In this embodiment, cylindrical portion 516 thereof supports on the exterior wall 516a a foil/plastic packet 550 which may support therein strips 551 of secondary products used in association with the beverage contained within bottle 510. The foil/paper packet 550 is adhesively sealed to the exterior surface 516 of bottle 510. The foil/paper packet may be removed from the bottle so that access to the strips in the foil/paper packet is permitted.

A still further embodiment of the present invention is shown with respect to FIG. 8. A beverage container cap 600 is shown. Cap 600 is of generally conventional construction having a cylindrical wall 616 and a closed upper surface 618. The cap may be attached by screw threading or other similar techniques to the open upper end of a beverage container (not shown). The upper end 618 of cap 600 includes a concave recess 620 which may accommodate therein a secondary consumable product 635. A cover 638 of the type generally described above may be used to seal and enclose the secondary consumable product 635 within the cap 600.

### EXAMPLES

### Example 1

TABLE 1
Calcium in Center-Filled Chewing Gum

| Component | % by weight |
|---|---|
| Gum | |
| Gum base | 23.0 |
| Lecithin | 0.6 |
| Sorbitol | 49.705 |
| Mannitol | 15.00 |
| Glycerin | 9.5 |
| High Intensity Sweetener | 0.775 |
| Flavor | 1.42 |
| Total | 100.00 |
| Centerfill | |
| Carboxymethylcellulose* | 48.9503 |
| Flavor | 0.135 |
| High Intensity Sweetener | 0.025 |
| Calcium Carbonate** | 50.00 |
| Total | 100.00 |

*Comprised of 50.0% glycerin, 49.25% sorbitol solution and 0.75% carboxymethylcellulose having a molecular weight sufficient to provide a 2% aqueous solution with a viscosity between 2,500 to 5,000 cps.
**A composition containing 98-100% calcium carbonate obtained from Speciality Minerals Inc. of Adam Massachusetts under the trade name Calessence having an average particle size of 4.5 microns.

TABLE 2
Calcium in Beverage

| Component | Quantity |
|---|---|
| Calcium sulfate dihydrate | 0.9 g |
| Ascorbic acid | 0.03 g |
| Purified drinking water | 500 ml |

A center-filled calcium-fortified chewing gum is prepared according to the formulation in Table 1 above.

The center-filled chewing gum is prepared in a conventional manner. The gum shell is made by conventional blending of the ingredients with the gum base.

The centerfill portion is formed by cooking the ingredients until the resulting cooked centerfill has approximately 85% solids by weight. The product is formed by coextruding the shell mixture and centerfill mixture forming a rope having the centerfill within a tube formed from the shell mixture. The rope is fed into a rotary forming unit to firm individual pieces of the centerfill chewing gum composition of the present invention.

The final gum composition produces pieces of a chewing gum composition weighing about 3.8 g with a centerfill portion comprising about 16% by weight of the gum composition. The centerfill portion contains 304 mg of calcium carbonate providing 121.6 mg of available calcium per piece.

A calcium-fortified beverage is prepared according to the formulation in Table 2 above. More specifically, a calcium-fortified water is prepared by combining the ingredients listed in Table 2 in the indicated amounts.

The calcium-fortified water is added to a beverage bottle of the present invention. The water is added to the interior of the bottle. The bottle also has a cavity formed in the wall of the bottle, which has an open face flush with the bottle wall. An individual piece of the center-filled calcium-fortified chewing gum is added into the cavity. A cover is positioned over the open face to close the cavity. The combination of calcium-fortified water and chewing gum provides a supplemental dose of calcium upon consumption by an individual. The calcium is consumed in multiple delivery vehicles over an extended period of time.

### Example 2

TABLE 3
Tingling Sensates in Breath Film

| | % by weight |
|---|---|
| Component | (wet basis) |
| Sweetener blend (xylitol, Ace-sulfame K, sucralose) | 2.82 |
| Water | 66.32 |
| Color solution (FD&C Yellow #6) | 2.00 |
| Hydrocolloid blend (sodium alginate, pectin, | 17.47 |
| modified starch) | |
| Flavor | 7.76 |
| Sensate (Tingling agent¹ + cooling agent²) | 0.40 |
| Plasticizer (glycerin) | 3.23 |

¹Proprietary component marketed under No. 596780 from Givaudan
²Proprietary component marketed as “Cooler 2” from IFF

TABLE 4
Tingling Sensates in Beverage

| Component | Weight in g |
|---|---|
| High fructose corn syrup-55 (77 deg Brix) | 160.00 |
| Citric acid, anhydrous | 2.50 |
| Tingling agent¹ | 0.50 |
| Water | 837.00 |

¹Proprietary component marketed under No. 596780 from Givaudan

A breath film is prepared according to the formulation in Table 3 above.

The film is prepared by first dissolving the sweeteners (xylitol, Ace-sulfame K and sucralose) and color in water. The hydrocolloids are added and dispersed in the solution. A high shear mixer is used, as necessary, to remove lumps. The hydrocolloids are allowed to hydrate for one and a half hours, after which the plasticizer (glycerine), sensates and flavor are added. The batch is mixed and allowed to rest for fifteen to thirty minutes.

Subsequently, the film is cast on a hot plate at 74° C. In particular, a water bath is placed on the hot plate, and the film is cast onto a stainless steel plate that is placed above the water bath. If the temperature of the hot plate becomes too high, i.e., boiling water, the film fuses to the plate causing difficulties in removal. Once dried, the film is peeled from the plate and after equilibration (about twenty-four hours) strips are cut.

A liquid beverage is prepared according to the formulation in Table 4 above. The beverage composition is prepared by combining the above-listed ingredients, stirring to mix and pasteurizing at about 190° F. for about two minutes.

The beverage is added to a cylindrical beverage bottle of the present invention. The beverage is added to the interior of the cylindrical bottle. An individual tingling breath film is placed within a foil/plastic packet. The packet is positioned on and attached to the exterior wall of the cylindrical bottle. The combination of tingling beverage and breath film provides a synergistic tingling sensation upon consumption by an individual. If the individual sequentially consumes the products, the tingling sensation also is extended for a period of time.

### Example 3

TABLE 5
Cholesterol Reducing Agent in Center-Filled Chewing Gum

| Component | % by weight |
|---|---|
| Gum | |
| Gum base | 23.0 |
| Lecithin | 0.6 |
| Sorbitol | 49.705 |
| Mannitol | 15.00 |
| Glycerin | 9.5 |
| High Intensity Sweetener | 0.775 |
| Flavor | 1.42 |
| Total | 100.00 |
| Centerfill | |
| Glycerin | 24.92 |
| Sorbitol Solution | 24.546 |
| Carboxymethylcellulose | 37.38 |
| Flavor | 0.135 |
| High Intensity Sweetener -Ace-K | 0.025 |
| Plant stanol | 50.00 |
| Total | 100.00 |

TABLE 6
Cholesterol Reducing Agent in Beverage

| Component | % by weight |
|---|---|
| Water Soluble Phase | |
| Water | 83.20 |
| Emulsifier | 5.0 |
| Sucrose | 11.0 |
| Acidulant | 0.3 |
| Flavor compounds | 0.1 |
| Color compounds | 0.1 |
| Oil Soluble Phase | |
| Sterol esters | 0.3 |

A center-filled chewing gum is prepared according to the formulation in Table 5 above.

The gum base formulation is prepared by blending the ingredients listed in Table 5 together in a gum extruder. The center fill formulation is prepared from the ingredients listed in Table 6. A solution blended from glycerin and sorbitol is prepared and heated to about 60° C. Carboxymethyl cellulose having a suitable molecular weight sufficient to provide a 2% aqueous solution with a viscosity of from about 2,500 to 5,000 cps, is slowly added to the glycerin and sorbitol solution and is blended until completely dissolved. A high intensity sweetener such as acesulfame-K is added followed by the flavor. The plant stanol is then added to the mixture and continuously blended to prevent any separation.

The finished gum product is formed by coextruding the gum base formulation through an orifice to produce a hollow-centered rope of chewing gum with the center fill formulation fed, under pressure, through an inner conduit to the hollow center of the rope. The resulting rope of center fill chewing gum is fed into a rotary sizing unit to form individual pieces of the final center fill chewing gum composition. The final center fill gum composition yields pieces of chewing gum each weighing about 3.8 g and composed of 84% by weight gum base and 16% by weight center fill, each of which is based on the total weight of the chewing gum composition. The center fill portion is measured to contain about 304 mg of plant stanol per piece of finished chewing gum.

A cholesterol reducing beverage is prepared according to the formulation in Table 6 above. More specifically, the beverage is prepared by combining the ingredients listed in Table 6 in the indicated amounts. An eight ounce beverage serving (240 g) will deliver the desired amount of sterol esters (0.65 g).

The cholesterol reducing beverage is added to a beverage bottle of the present invention. The beverage is added to the interior of the bottle. The bottle also has a cavity formed in the wall of the bottle, which has an open face flush with the bottle wall. An individual piece of the center-filled cholesterol reducing chewing gum is added into the cavity. A cover is positioned over the open face to close the cavity. The cholesterol reducing agents contained in the beverage and chewing gum are different (i.e., stanol in the chewing gum and sterol esters in the beverage) but complementary as the ingredients perform the same function upon consumption by an individual.

### Example 4

TABLE 7
Chewable Vitamin Tablet

| Component | % by weight |
|---|---|
| Vitamin C (ascorbic acid) as ascorbic acid solution | 70.0 |
| mixture 1:1 | |
| Vitamin B₁ (thiamine mononitrate) as ROCOAT ® | 4.0 |
| Vitamin B₂ (riboflavin) as ROCOAT ® riboflavin 33⅓% | 5.0 |
| Vitamin B₆ (pyridoxine hydrochloride) as ROCOAT ® | 33.0 |
| pyridoxide hydrochloride 33⅓% | |
| Calcium pantothenate | 11.5 |
| Vitamin B₁₂ (cyanocobalamin) as Merck 0.1% in gelatin | 3.5 |
| Vitamin E (d1-alpha tocopheryl acetate as | 6.6 |
| dry vitamin E acetate 33⅓% Roche) | |
| d-Biotin | 0.044 |
| Certified lake color | 5.0 |
| Flavor | 5.0 |
| Sweetener - sodium saccharin | 1.0 |
| Magnesium stearate lubricant | 10.0 |
| Mannitol q.s. to make | 500.00 |

TABLE 8
Vitamin-Fortified Beverage

| Component | Weight in g |
|---|---|
| Granular sucrose | 13.39 |
| Citric Acid | 0.17 |
| Sodium Benzoate | 0.05 |
| Starch | 0.02 |
| Flavor oil | 0.008 |
| Ester gum | 0.0065 |
| Colors | 0.006 |
| Butylated hydroxyanisole (BHA) | 0.00004 |
| Riboflavin | 0.0003 |
| Ascorbic acid | 0.007 |
| β-carotene | 0.06 |
| Ferrous gluconate (11.6%) | 0.008 |
| Calcium chloride | 0.11 |
| Water | 36.9 |
| Carbonated water | 49.02 |

A chewable vitamin tablet is prepared according to the formulation in Table 7 above.

The ingredients in Table 7 are combined in the indicated amounts. Tablets are prepared by slugging, with flatfaced punches and grinding the slugs to 14 mesh. 13.5 Grams of dry Vitamin A acetate and 0.6 grams of vitamin D are then added as beadlets. The entire blend is then compressed using concave punches at 0.5 grams each.

A carbonated vitamin-fortified beverage is prepared according to the formulation in Table 8 above.

Water (10 grams) is used to dissolve the sodium benzoate, riboflavin, β-carotene and sugar. To this solution is added the calcium chloride. Separately a solution of ferrous gluconate and part of the vitamin C (ascorbic acid, 0.008 grams) is prepared in a portion of the remaining water. This makes a ferrous gluconate/ascorbate mixture which is then added to the concentrate. A flavor concentrate containing flavor oils, gums, colors, starch and BHA are then added to this concentrate.

Finally the remaining vitamin C is added to the syrup after the syrup is blanketed with nitrogen. This final syrup is diluted with the carbonated water.

This carbonated drink (180 ml) has a recommended daily allowance of 21% vitamin C, 11% to 12% calcium, 10% iron, 32% riboflavin, and 18% vitamin A equivalent.

The carbonated vitamin-fortified beverage is added to a beverage bottle of the present invention. The beverage is added to the interior of the bottle. The bottle also has a cavity formed in the wall of the bottle, which has an open face flush with the bottle wall. An individual chewable vitamin tablet is added into the cavity. A cover is positioned over the open face to close the cavity. The combination of vitamin-fortified beverage and chewable tablet provides a supplemental dose of vitamins upon consumption by an individual. A variety of different vitamins are provided by the multiple delivery vehicles and may be consumed sequentially to deliver the vitamins over an extended period of time.

### Example 5

TABLE 9
Appetite-Suppressing Chocolate Meltaway Confection

| Component | Quantity | |
|---|---|---|
| Griffonia simplicifolia extract | 7.5 | g |
| Pyridoxyl-5-phosphate | 2.5 | g |
| Chromium polynicotinate | 100 | mg |
| Ginger extract | 2.5 | g |
| Maltitol confection base | 400 | g |
| Ethanol (95%) | 25 | ml |

TABLE 10
Energy Water

| Component | Quantity | |
|---|---|---|
| L-carnitine | 500 | mg/liter |
| Garcinia Cambogia | 700 | mg/liter |
| Chromium Polynicotinate | 100 | mcg/liter |
| Calcium | 70 | mg/liter |
| Potassium | 100 | mg/liter |
| Magnesium | 12 | mg/liter |
| Zinc | 1.25 | mg/liter |
| Selenium | 15 | mg/liter |
| Vitamin B6 | 0.7 | mg/liter |
| Vitamin B12 | 2.12 | mcg/liter |
| Folic Acid | 140 | mcg/liter |
| Niacin | 2.75 | mcg/liter |
| Ca Pantothenate | 1.5 | mg/liter |
| Vitamin C | 4.25 | mg/liter |
| L-Aspartic Acid | 300 | mg/liter |
| Natural aroma | 150 | mg/liter |

A crave-reducing confection is prepared according to the formulation in Table 9 above.

The griffonia simplicifolia extract, pyridoxyl-5-phosphate, chromium polynicotinate and ginger extract are combined, mixing the powders thoroughly in a lab blender. Griffonia simplicifolia extract is a source of 5-hydroxytryptophan, which is a crave-reducing agent. The maltitiol chocolate confection base is heated to approximately 200 degrees Fahrenheit. The ethanol is added to the powder mixture to dissolve ingredients. The solution is added to the candy base and is mixed to uniformly disperse ingredients. The mixture is poured into prepared molds. The candy pieces are wrapped individually.

An energy fitness beverage is prepared according to the formulation in Table 10 above. More specifically, an energy fitness water is prepared by combining the ingredients listed in Table 10 in the indicated amounts. Several ingredients, including garcinia combogia and chromium, are known appetite suppressants.

The energy water is added to a beverage bottle of the present invention. The water is added to the interior of the bottle. The bottle also has a cavity formed in the wall of the bottle, which has an open face flush with the bottle wall. An individual crave-reducing chocolate confection is added into the cavity. A cover is positioned over the open face to close the cavity. The combination of energy water and crave-reducing confection provides a complementary effect of suppressing an individual's appetite upon consumption.

### Example 6

TABLE 11
Decongestant in Film

| | % by weight |
|---|---|
| Component | (wet basis) |
| Sweetener blend (xylitol, Ace-sulfame K, sucralose) | 2.82 |
| Water | 66.32 |
| Color solution (FD&C Yellow #6) | 2.00 |
| Hydrocolloid blend (sodium alginate, pectin, | 17.47 |
| modified starch) | |
| Flavor | 7.76 |
| Decongestant | 0.40 |
| Plasticizer (glycerin) | 3.23 |

TABLE 12
Warming Agent in Beverage

| Component | Weight in g |
|---|---|
| High fructose corn syrup-55 (77 deg Brix) | 160 |
| Citric acid, anhydrous | 2.5 |
| Warming agent and flavor | 0.5 |
| Water | 837 |

A film strip incorporating a decongestant, such as pseudoephedrine, is prepared according to the formulation in Table 11 above.

The film is prepared by first dissolving the sweeteners (xylitol, Ace-sulfame K and sucralose) and color in water. The hydrocolloids are added and dispersed in the solution. A high shear mixer is used, as necessary, to remove lumps. The hydrocolloids are allowed to hydrate for one and a half hours, after which the plasticizer (glycerine), decongestant and flavor are added. The batch is mixed and allowed to rest for fifteen to thirty minutes.

Subsequently, the film is cast on a hot plate at 74° C. In particular, a water bath is placed on the hot plate, and the film is cast onto a stainless steel plate that is placed above the water bath. If the temperature of the hot plate becomes too high, i.e., boiling water, the film fuses to the plate causing difficulties in removal. Once dried, the film is peeled from the plate and after equilibration (about twenty-four hours) strips are cut.

A liquid beverage, which imparts a warming sensation upon consumption, is prepared according to the formulation in Table 12 above. The beverage composition may be prepared by combining the above-listed ingredients, stirring to mix and pasteurizing at about 190° F. for about two minutes.

The beverage is added to a cylindrical beverage bottle of the present invention. The beverage is added to the interior of the cylindrical bottle. An individual decongestant film is placed within a foil/plastic packet. The packet is positioned on and attached to the exterior wall of the cylindrical bottle. The beverage complements the decongestant film by soothing the individual user's symptoms upon consumption. In particular, cold-like symptoms often include congestion and chills. A beverage providing a warming sensation upon consumption may soothe the individual's symptoms as the active ingredients in the film act to decongest. Example 7

TABLE 13
Caffeinated Chewing Gum

| Component | % by weight |
|---|---|
| Sugar | 60.8 |
| Gum base | 19.2 |
| Corn syrup | 12.9 |
| Lecithin | 0.2 |
| Peppermint | 0.9 |
| Flavor liquid/caffeine blend | 6.0 |

A caffeinated chewing gum is prepared according to the formulation provided in Table 13 above. The chewing gum is prepared in accordance with conventional practice. A 10.0 gram portion of the caffeine is dissolved in 90.0 grams of hot water, making a 10.0% solution, and added to the gum.

A ginseng beverage is prepared in accordance with the following. 2.5 kg of white ginseng, 1.5 kg of Schizandrae Frutus and 40 L of water are mixed together in an extraction tank and boiled for 4 hr (the internal temperature is 120° C.). After removing 20 L of water by evaporation, the mixture is added with 48 L of ethanol, boiled for 2 hours, cooled down to room temperature and filtrated (First filtrate).

The residue is added with 18 L of water and 48 L of ethanol, heated to boil for 3 hours, cooled down and filtered (Second filtrate). The combined mixture of first and second filtrate is concentrated until it is reduced to one third in volume, spray-dried and a powder of the processed ginseng extract is finally obtained.

10 g of the processed ginseng extract powder, 1 g of citric acid, 1 g of gum arabic and 5 g of sugar are dissolved in purified water to the final volume of 100 mL. The mixture is sterilized for 15 seconds at 95° C. and cooled down and drinks are manufactured.

The ginseng beverage is added to a beverage bottle of the present invention. The beverage is added to the interior of the bottle. The bottle also has a cavity formed in the wall of the bottle, which has an open face flush with the bottle wall. An individual piece of the caffeinated chewing gum is added into the cavity. A cover is positioned over the open face to close the cavity. The combination of a ginseng-enhanced beverage and caffeinated chewing gum provides a complementary energy boost to an individual upon consumption.

What is claimed is:

1. A packaging device for placing a consumable product in combination with a beverage comprising:
a container surface forming at least part of a beverage container;
a recess formed in said surface for supporting said consumable product;
a cover overlying said recess and sealing said consumable product;
wherein an association is provided between the beverage and the consumable product which provides enhancement of consumption of the beverage and the consumable product.

2. A combination container for a beverage and a secondary consumable product comprising:
a beverage bottle having a wall defining an interior for accommodating said beverage, said bottle having formed therein a cavity for accommodating said secondary consumable product; said cavity having a closed end extending into the interior of the bottle and an open face flush with said wall; and
a cover overlying said open face of said cavity for sealably closing said cavity.

3. A combination container of claim 2 wherein said bottle has a cylindrical wall and said cavity is formed on said cylindrical wall.

4. A combination container of claim 2 wherein said bottle has a frustoconical wall extending to a bottle opening and wherein said cavity is formed on said frustoconical wall.

5. A combination container of claim 2 wherein said bottle has a closed bottom and wherein said cavity is formed on said closed bottom.

6. A combination container of claim 2 wherein said cover is releaseably adhesively secured over said open face of said cavity.

7. A product comprising:
a container having a consumable liquid composition contained therein, said liquid composition comprising a first component; and
a confectionery delivery vehicle located on an external surface of said container, said delivery vehicle comprising a second component,
wherein said first component and said second component are the same or different and are selected from the group consisting of a flavor, a sensate, a bioactive agent, a nutritional supplement and a pharmaceutical agent.

8. The product of claim 7, wherein said first component and said second component comprise calcium.

9. The product of claim 7, wherein said first component and said second component comprise cholesterol reducing agents.

10. The product of claim 7, wherein said first component and said second component comprise vitamins.

11. The product of claim 7, wherein said first component and said second component comprise appetite suppressants.

12. The product of claim 7, wherein said first component comprises an energy boosting agent and said second component comprises caffeine.

13. The product of claim 7, wherein said first component comprises a warming agent and said second component comprises a decongestant.

14. A product comprising:
a container having a consumable liquid composition contained therein, said liquid composition comprising a first component for providing a sensory experience or health benefit; and
a confectionery delivery vehicle located on an external surface of said container, said delivery vehicle comprising a second component for supplementing, complimenting or enhancing said sensory experience or health benefit.

15. A method of modulating a sensory experience or health benefit to a consumer, comprising the steps of:
(a) providing a product comprising:
(i) a container having a consumable liquid composition contained therein, said liquid composition comprising a first component; and
(ii) a confectionery delivery vehicle located on an external surface of said container, said delivery vehicle comprising a second component,
wherein said first component and said second component are the same or different and are selected from the group consisting of a flavor, a sensate, a bioactive agent, a nutritional supplement and a pharmaceutical agent;
(b) applying said liquid composition into the oral cavity of an individual, thereby delivery said first component to the individual; and
(c) subsequently applying said delivery vehicle into the oral cavity of the individual, thereby delivering said second component to the individual.
